(19) United States
(12) Patent Application Publication
(10) Pub. No.: US 2015/0304450 A1
(43) Pub. Date: Oct. 22, 2015

(54) METHOD AND APPARATUS FOR NETWORK FUNCTION CHAINING

(71) Applicant: Alcatel Lucent Canada,Inc., Ottawa (CA)

(72) Inventor: Jeroen van BEMMEL, Calgary (CA)

(73) Assignee: Alcatel Lucent Canada,Inc., Ottawa (CA)

(21) Appl. No.: 14/255,224

(22) Filed: Apr. 17, 2014

(51) Int. Cl. H04L 29/08; H04L 12/911; H04L 12/24

(52) U.S. Cl. CPC H04L 67/32; H04L 41/0893; H04L 47/829

(57) ABSTRACT

Various exemplary embodiments relate to a method, network node, and non-transitory machine-readable storage medium including one or more of the following: receiving, at the host device, a first received message including a first identification of a first network function; removing the first identification of the first network function from the first received message to create a first modified message; and transmitting the first modified message to a first network function device for performance of the first network function with respect to the first modified message. Various embodiments are described wherein: the first received message includes a bitmap including a plurality of bit positions respectively corresponding to a plurality of network functions, and the first indication of a first network function comprises a bit within the bitmap at a bit position corresponding to the first network function.

### TECHNICAL FIELD

Various exemplary embodiments disclosed herein relate generally to message routing and, more particularly but not exclusively, to routing of messages through a chain of network functions in a cloud computing environment.

### BACKGROUND

As cloud computing becomes more prevalent, enterprises and other entities are seeking to migrate varying types of applications into cloud data centers. One challenge that arises in many such migrations is the problem of how to perform various network functions on traffic associated with the application. In non-cloud deployments, these network functions may simply be provided by placing the network functions between the source and destination in the network topology. For example, a web server might be placed behind a firewall to ensure web traffic traverses the firewall function. Once the web server and firewall function are migrated to a cloud computing environment it may not be possible or desirable to enforce the firewall through topology alone. For example, the dynamic nature of the cloud may enable the migration of the web server between data centers or the establishment of clone web servers at different data centers.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method performed by a host device for directing a message through a network function, the method including: receiving, at the host device, a first received message including a first identification of a first network function; removing the first identification of the first network function from the first received message to create a first modified message; and transmitting the first modified message to a first network function device for performance of the first network function with respect to the first modified message.

Various embodiments described herein relate to a host device for directing a message through a network function, the host device including: a network interface; a memory storing a switch configuration; and a processor in communication with the network interface and memory, the processor being configured to: support a plurality of virtualized devices assigned to a respective plurality of slots, and implement a virtualized switch, wherein the switch is configured to: receive, via the network interface, a first received message including a first identification of a first slot of the plurality of slots, remove, based on the switch configuration, the first identification of the first slot from the first received message to create a first modified message, and transmit the first modified message to a first virtualized device supported by the first slot.

Various embodiments described herein relate to a non-transitory machine-readable storage medium encoded with instructions for execution by a host device for directing a message through a network function, the non-transitory machine-readable storage medium including: instructions for receiving, at the host device, a first received message including a first identification of a first network function; instructions for removing the first identification of the first network function from the first received message to create a first modified message; and instructions for transmitting the first modified message to a first network function device for performance of the first network function with respect to the first modified message.

Various embodiments are described wherein the first received message additionally includes a second identification of a second network function, the method further including: receiving, at the host device and based on transmitting the first modified message, a second received message including the second identification of the second network function; removing the second identification of the second network function from the second received message to create a second modified message; and transmitting the second modified message to a second network function device for performance of the second network function with respect to the second modified message.

Various embodiments are described wherein the first network function device is a virtualized device supported by the host device.

Various embodiments are described wherein the first received message includes a bitmap including a plurality of bit positions respectively corresponding to a plurality of network functions, and the first indication of a first network function includes a bit within the bitmap at a bit position corresponding to the first network function.

Various embodiments are described wherein the first identification of the first network function is at least partially represented in a destination address field of the first received message and removing the first identification of the first network function includes modifying the value of the destination address field.

Various embodiments are described wherein the first received message is received from an external router, the method further including, before receiving the first received message: receiving, at the host device from the external router, an address resolution request specifying a first address; and transmitting, by the host device to the external router, an address resolution response specifying a second address as being associated with the first address, wherein the second address includes the first identification of the first network function.

Various embodiments are described wherein the host device supports a plurality of slots via which a plurality of devices are reachable, wherein a first slot of the plurality of slots supports the first network function device, and the step of removing the first identification of the first network function from the first received message to create a first modified message includes, prior to transmitting the first modified message to the first slot: setting the destination address field of the first modified message equal to an address of a second slot of the plurality of slots other than the first slot.

### BRIEF DESCRIPTION OF THE DRAWINGS

In order to better understand various exemplary embodiments, reference is made to the accompanying drawings, wherein:

FIG. 1 illustrates an exemplary cloud environment;

FIG. 2 illustrates a hardware diagram of an exemplary host device;

FIG. 3 illustrates exemplary coding schemes for an IP address;

FIG. 4 illustrates a functional diagram of an exemplary host device;

FIG. 5 illustrates a functional diagram of an exemplary host device implementing a particular application;

FIG. 6 illustrates exemplary coding schemes for a MAC address;

FIG. 7 illustrates exemplary rules for a switch;

FIG. 8 illustrates an exemplary method for supporting address resolution; and

FIG. 9 illustrates an exemplary method for forwarding a received message.

To facilitate understanding, identical reference numerals have been used to designate elements having substantially the same or similar structure or substantially the same or similar function.

### DETAILED DESCRIPTION

With the unpredictable topology provided by the cloud and the practice of assigning random addresses for cloud devices, the problem of placing a firewall at a location in the topology that is to be traversed is non-trivial. Further, binding the firewall location to the web server in this way may prevent full realization of the benefits of cloud computing as an ideal location for the firewall may be unused due to the topological requirement that the firewall be placed in front of the web server. It will be apparent that similar issues arise with other applications and other network functions beyond the example of the web server and firewall. Accordingly, various embodiments described herein provide a system that facilitates deployment of applications with associated network function chains in a topologically-meaningful manner.

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., or), unless otherwise indicated (e.g., “or else” or “or in the alternative”). Additionally, the various embodiments described herein are not necessarily mutually exclusive and may be combined to produce additional embodiments that incorporate the principles described herein.

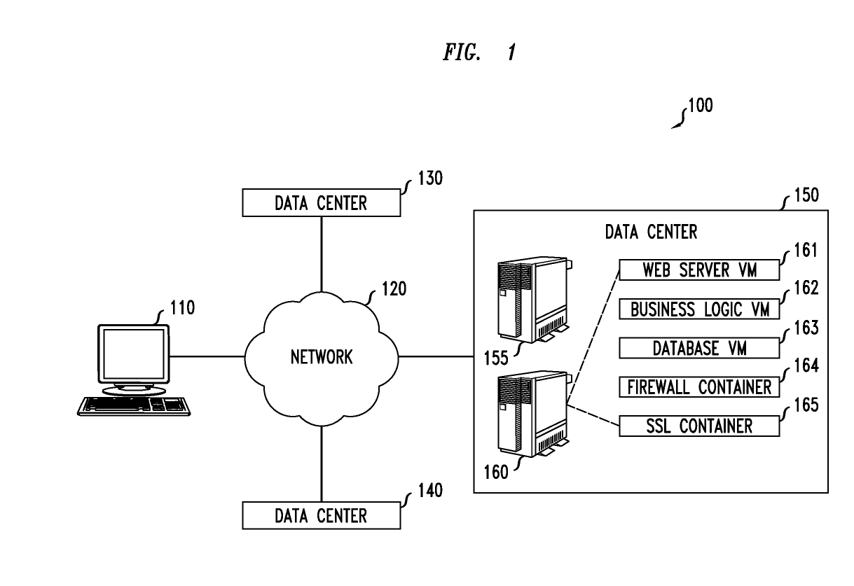

FIG. 1 illustrates an exemplary cloud environment 100. As shown, the cloud environment 100 includes a user device 110 connected to a network 120. The user device 110 may be any device operable by a user to communicate via a network. For example, the user device 110 may be a desktop computer, laptop, tablet, mobile phone, set top box, or video game console. Further, the network 120 may be any network capable of facilitating inter-device communication. In various embodiments, the network 120 includes an IP/Ethernet network and may include the Internet.

The cloud environment also includes multiple data centers 130, 140, 150. It will be apparent that fewer or additional data centers may exist within the cloud environment. The data centers 130, 140, 150 each include collections of hardware that may be dynamically allocated to supporting various cloud applications. In various embodiments, the data centers 130, 140, 150 may be geographically distributed; for example, data centers 130, 140, 150 may be located in Washington, D.C.; Seattle, Wash.; and Tokyo, Japan, respectively.

Each data center 130, 140, 150 includes host devices for supporting virtualized devices, such as virtual machines and containers. For example, data center 150 is shown to include two host devices 155, 160, which may both include various hardware resources. It will be apparent that the data center 150 may include fewer or additional host devices and that the host devices may be connected to the network 120 and each other via one or more networking devices such as routers and switches. In various embodiments, the host devices 155, 160 may be personal computers, servers, blades, or any other device capable of contributing hardware resources to a cloud environment.

The various host devices 155, 160 may support one or more cloud-based applications. For example, host device 160 is shown to support a web application including a web server virtual machine (hereinafter, “VM”) 161, business logic VM 162, and a database VM 163. As will be understood, a VM is an instance of an operating system and application code running on hardware provided by a host device. The web application, as shown, is also associated with two network functions: a firewall function and a secure sockets layer (hereinafter, “SSL”) function. For example, the web application may require that all traffic to the web server VM 161 traverse a firewall and according to SSL procedures. Various alternative or additional network functions will be apparent such as, for example, load balancers, HTTPS, encryption, and decryption. Such functionality may be provided as separate VMs or, as illustrated, in another type of virtualized device termed a “container.” As will be understood, a container is similar to a VM in that it provides virtualized functionality but, unlike a VM, may not include a separate OS instance and, instead, may use the OS or kernel of the underlying host system. Various types of containers may be used such as, for example, Linux Containers, OpenVZ, Linux-VServer, FREEBSD jails, AIX Workload Partitions, or Solaris Containers. As shown, the host device 160 also supports a firewall container 164 and an SSL container 165 for implementing the associated network functionalities.

While the virtualized devices 161-165 are described as being co-resident on a single host device 160, it will be apparent that various additional configurations are possible. For example, one or more of the virtualized devices 161-165 may be hosted among one or more additional host devices 155 or among one or more additional data centers 130-150. As another example, additional instances of the virtualized devices 161-165 may be hosted among one or more additional host devices 155 or among one or more additional data centers 130-150 thereby providing redundancy and the possibility of load balancing.

It will be apparent that while the exemplary cloud environment 100 is described in terms of a user device accessing a web application, the methods described herein may be applied to various alternative environments. For example, alternative environments may provide software as a service to a user tablet device or may provide backend processing to a non-end user server. Various alternative environments will be apparent.

While the various data centers 130, 140, 150 may implement VMs or containers providing the desired network functionality, the mere existence of the virtualized devices in many embodiments is insufficient to ensure that traffic associated with the application will be processed according to the desired network functionality. Instead, the network function devices 164, 165 should receive the messages associated with the application to enable the desired processing.

According to various embodiments, the host device 160 implements a virtualized switch for directing messages received by the host device 160 to appropriate virtualized devices 161-165 or other devices or virtualized devices hosted on other host devices or in difference data centers. As will be described in greater detail below, in some such embodiments, the virtualized switch is provided with instructions, such as code or configuration information, for forwarding traffic through a sequence of network function devices before being forwarded to the application VM. As such, the switch may forward traffic to locally hosted virtualized devices or to external devices or virtualized devices.

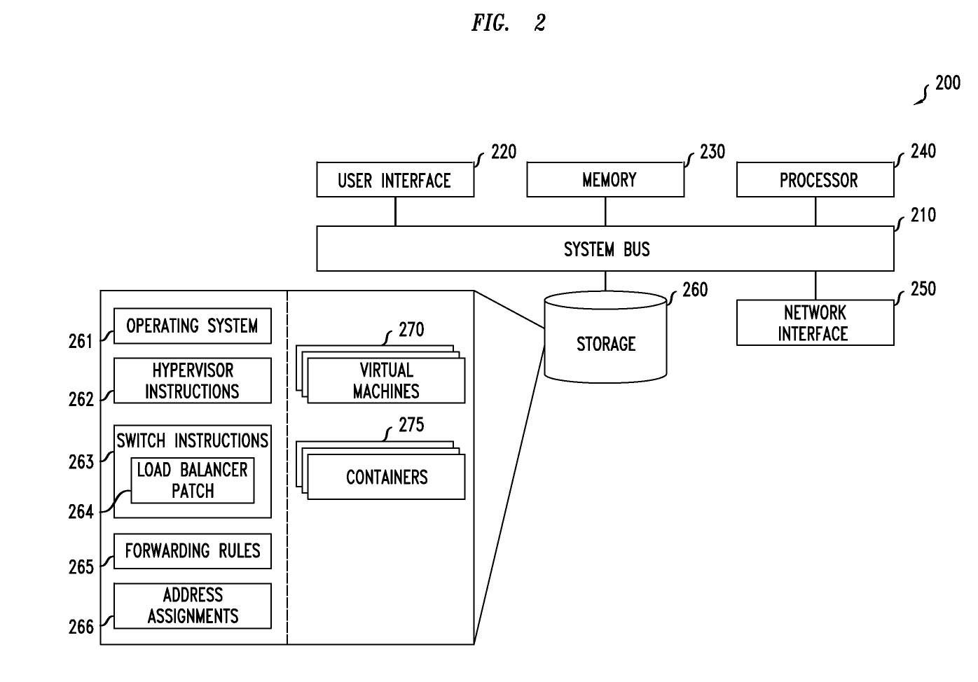

FIG. 2 illustrates a hardware diagram of an exemplary host device 200. The exemplary host device 200 may correspond to one or more of the host devices, including host devices 155, 160, of the exemplary cloud environment. As shown, the host device 200 includes a processor 220, memory 230, user interface 240, network interface 250, and storage 260 interconnected via one or more system buses 210. It will be understood that FIG. 2 constitutes, in some respects, an abstraction and that the actual organization of the components of the host device 200 may be more complex than illustrated.

The processor 220 may be any hardware device capable of executing instructions stored in memory 230 or storage 260 or otherwise processing data. As such, the processor may include a microprocessor, field programmable gate array (FPGA), application-specific integrated circuit (ASIC), or other similar devices.

The memory 230 may include various memories such as, for example L1, L2, or L3 cache or system memory. As such, the memory 230 may include static random access memory (SRAM), dynamic RAM (DRAM), flash memory, read only memory (ROM), or other similar memory devices.

The user interface 240 may include one or more devices for enabling communication with a user such as an administrator. For example, the user interface 240 may include a display, a mouse, and a keyboard for receiving user commands. In some embodiments, the user interface 240 may include a command line interface or graphical user interface that may be presented to a remote terminal via the network interface 250.

The network interface 250 may include one or more devices for enabling communication with other hardware devices. For example, the network interface 250 may include a network interface card (NIC) configured to communicate according to the Ethernet protocol. Additionally, the network interface 250 may implement a TCP/IP stack for communication according to the TCP/IP protocols. Various alternative or additional hardware or configurations for the network interface 250 will be apparent.

The storage 260 may include one or more machine-readable storage media such as read-only memory (ROM), random-access memory (RAM), magnetic disk storage media, optical storage media, flash-memory devices, or similar storage media. In various embodiments, the storage 260 may store instructions for execution by the processor 220 or data upon with the processor 220 may operate. For example, the storage 260 may store a base operating system 261 and hypervisor instructions for managing various virtualized devices. The storage also includes switch instructions 263 for forwarding messages to appropriate locally-hosted or remote virtualized devices or other devices. In various exemplary embodiments, the switch instructions may be instructions for implementing OpenVSwitch. Various alternative virtualized switch instructions will be apparent. In some embodiments, the switch instructions 263 may also include a load balancer patch 264 that provides instructions for balancing the workload between multiple virtualized devices. The storage 260 also includes switch configuration information such as forwarding rules 265, for determining based on a destination MAC address which virtualized machine should receive a message, and address assignments, for determining based on a destination IP address to which MAC address a message should be sent.

The storage 260 also stores a plurality of VM images 270 and container images 275 for use in providing an application. For example, one or more of the images 270, 275 may be instantiated and stored in the memory 230 as a running virtualized device. As such, the VM images 270 may include a web server VM and database VM, while the container images 275 may include a firewall container and an SSL container.

It will be apparent that various information described as stored in the storage 260 may be additionally or alternatively stored in the memory 230. For example, one or more copies of a virtual machine image 270 may be instantiated in the memory 230. In this respect, the memory 230 may also be considered to constitute a “storage device” and the storage 260 may be considered a “memory.” Various other arrangements will be apparent. Further, the memory 230 and storage 260 may both be considered to be “non-transitory machine-readable media.” As used herein, the term “non-transitory” will be understood to exclude transitory signals but to include all forms of storage, including both volatile and non-volatile memories.

While the host device 200 is shown as including one of each described component, the various components may be duplicated in various embodiments. For example, the processor 220 may include multiple microprocessors that are configured to independently execute the methods described herein or are configured to perform steps or subroutines of the methods described herein such that the multiple processors cooperate to achieve the functionality described herein.

According to various embodiments, the virtual switch implemented by the host device utilizes an IP addressing scheme that is topologically structured. Such a scheme facilitates co-location of network functions and replication of network functions across servers and data centers without extensive switching and routing of packets between specific instances of the desired network functionality. FIG. 3 illustrates exemplary coding schemes 300 for an IP address. As will be understood, various alternative schemes may be used within the scope of the described embodiments. For example, bitfields may be resized or removed entirely.

As shown, two IP addresses 310, 320 may be interpreted according to one of two schemes respectively and, as such, may be used to address different types of items. Specifically, the first address 310 may address a specific “slot” (e.g. a virtualized device or other output port from the virtualized switch) while the second address 320 may address a specific application, which may involve routing the traffic through multiple slots (e.g., for performing network functions) before reaching the final destination. Both schemes include a class A range 331 (here, set to “135”), a data center range 332 for indicating a specific data center to which traffic is destined (or set to “0” for anycast traffic), a rack range 333 and server range 334 together specifying a rack and server to which traffic is destined (or both set to “0” for equal-cost multi-path routing (ECMP)), and a V bit 335. The V bit 335 may be used by the switch or the operator configuring switch to denote whether an IP address identifies a specific slot or an application. With the V bit 335 set to zero, the remaining field 335 identifies the specific slot, while a V bit set to one, the remaining field 335 identifies the application.

In the example of FIG. 3, the first address 310 has the V bit 335 set to zero and therefore may indicate that traffic should be forwarded directly to data center 3, rack 1, server 2, slot 5. The second address 320 on the other hand has the V bit 335 set to one and therefore may indicate that traffic should be forwarded as anycast ECMP traffic destined for application 1. The specific slots to which the switch will forward traffic destined for this second address 320 will depend on the configuration of the switch. As such, the operator may configure the chain of network functions on a per-application basis.

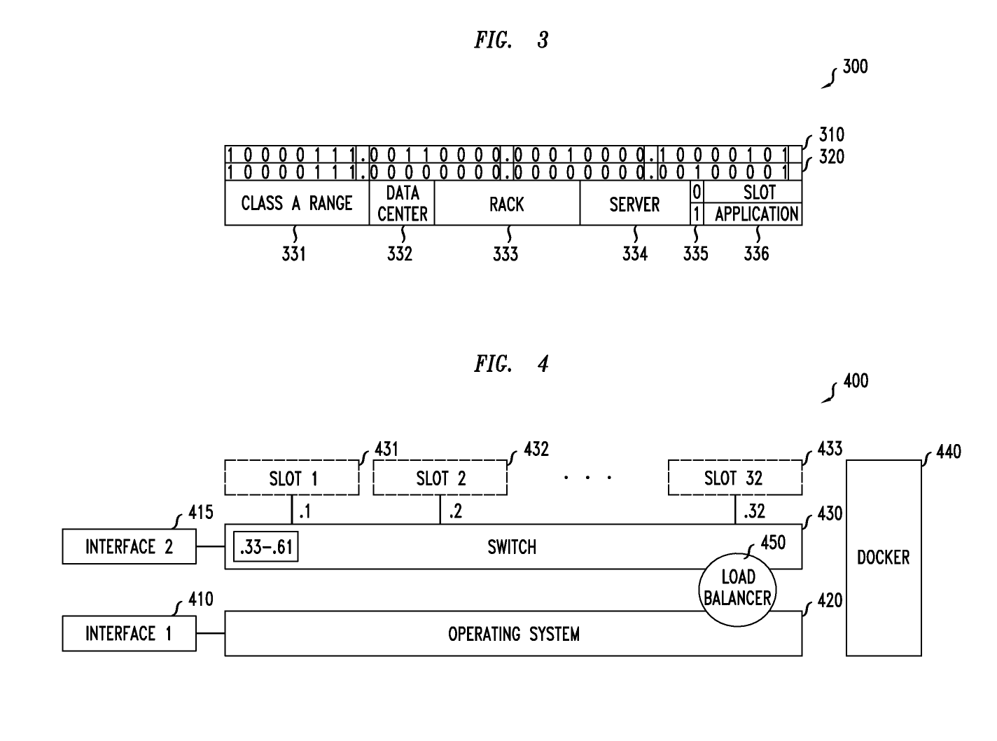

FIG. 4 illustrates a functional diagram of an exemplary host device 400. As shown, the host device includes two network interfaces 410, 415, though a single interface may be used. The first interface 410 may receive management messages and pass them to the underlying operating system 420 while the second interface 415 receives application traffic and forwards it to the switch 430, which may be virtualized. As shown, IP addresses that include final six bits in the range of 33-61 (i.e., IP addresses having the V bit 335 described in FIG. 3 set to one) are associated with applications and are directed to the switch 430 for processing. The switch is configured to send messages to various configured slots 431, 432, 433, which may correspond to local virtualized devices, remote virtualized devices, or other devices. As shown here, the switch supports 32 slots due to the fact that the slot field 336 consists of five bits. It will be understood that additional slots may be supported by expanding the slot field 336 or by using bits from other fields in the packet header or within the packet payload. As shown, each slot is associated with a unique address having the final six bits in the range of 1-32 (i.e., IP addresses having the V bit 335 described in FIG. 3 set to zero).

As further shown in FIG. 4, the host device may include a docker 440 (such as Docker.io) for managing various containers assigned among at least some of the slots 431-433. A load balancer 450 may also be implemented in the switch 430 or operating system 420 for performing a load balancing function at the switch 430 level. It will be appreciated that the load balancing functionality may alternatively be implemented as a virtualized device assigned to one of the slots 431-433 and that additional network functionality may be implemented as a patch directly to the switch 430 or operating system 420.

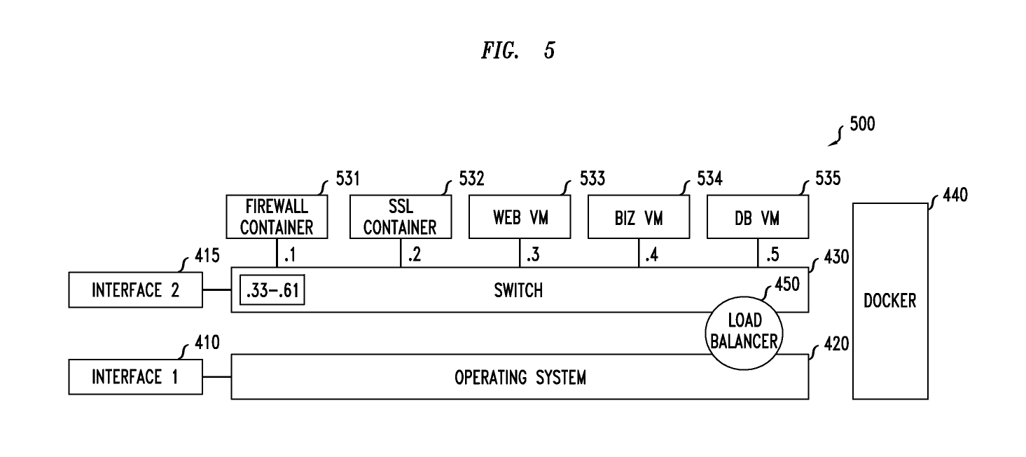

FIG. 5 illustrates a functional diagram of an exemplary host device 500 implementing a particular application. For example, the host device 500 may correspond to an implementation of the web application described with respect to the exemplary cloud environment 100 on the exemplary host device 400. As shown, five slots 531-535 are configured. The first two slots 531, 532 are assigned to a firewall container and an SSL container, respectively. The other three slots 533, 534, 535 are assigned to the web server VM, business logic VM, and database VM, respectively. As such, the switch 430 may be configured to forward traffic received for the web application through the firewall container 531, then the SSL container 532, and finally to the web server VM 533.

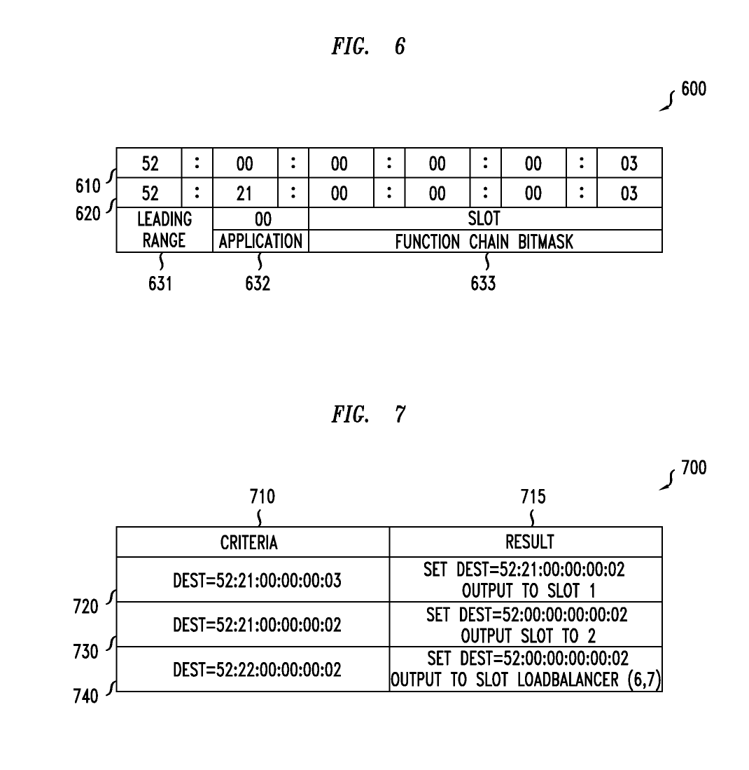

To facilitate network function chaining, various embodiments store state information regarding the network functions to be performed within the destination MAC address. FIG. 6 illustrates exemplary coding schemes 600 for a MAC address. As shown, two MAC addresses 610, 620 may be interpreted differently by the switch or operator configuring the switch depending on the scheme applied.

Both schemes include a leading range 631 which, here, is set to a value of 0x52 in both MAC addresses 610, 620. The next byte 632 may determine which scheme is applied to the MAC address. If the second byte 632 is set to zero, the remaining bytes 633 may identify a specific slot to which a frame should be directed. Thus, the first MAC address 610 indicates slot 3 specifically.

Otherwise, if the second byte 632 is a value other than zero, the second byte 632 is taken to identify an application with which the frame is associated. In this case, the remaining bytes 633 identify the chain of slots or network functions through which the message is to be passed prior to arriving at the final destination. In various embodiments, a bitmap is used to identify the chain of slots, with each bit position being associated with a specific slot. For example, the least significant bit (“lsb”) corresponds to slot 1, the bit next to the lsb corresponds to slot 2, and so forth. Setting a bit to one indicates that the slot associated with that bit position is to be traversed as part of the network function chain. It will be understood that alternative embodiments may instead use a zero to indicate that the associated slot is to be traversed. Thus, the second address 620 is associated with application 0x21 and a message destined for this address 620 is to traverse both slots 1 and 2 (because the bitmap 0x3 corresponds to bit 1 and 2 being set, 0b0011) prior to being directed to the final destination associated with application 0x21. Various alternatives to bitmaps to identify a chain of slots will be apparent. For example, an identifier corresponding to a pre-configured chain of slots or a list of identifiers associated with particular network functions may serve as identifications of network functions.

According to this exemplary scheme, it will be apparent that the four byte bitmap enables the use of 32 different network functions in constructing a network function chain. This limit may be adjusted by, for example, using additional or alternative locations in a frame to specify a bitmap or by resizing the other fields 631, 632. For example, four bits in the application field 632 may be moved to the bitmap field 633, thereby reducing the application ID range but adding four possible slots to the bitmap. Similarly, if a greater application ID space is desired, bits may be reassigned to the application field 632 from the leading range field 631 or the bitmap field 633.

It will be understood that while various embodiments are described herein as encoding application identifiers, slot identifiers, network function indications, and other information in destination IP and MAC addresses, that various other portions of the message may be additionally or alternatively used. For example, such information may be encoded in a VLAN ID, an IP options field, a ToS field, some other IP or MAC header field, or in the payload of the frame or packet.

Having established addressing or other application and chain identification conventions, such as those examples described with respect to FIGS. 3 and 6 above, the operator may configure the switch to direct messages to various slots as appropriate to identified applications, slots, or network function chains. For incoming traffic, where an operator desires to establish a specific function chain for a specific application, the operator may provide the switch with configuration information (such as the address assignments 266 of FIG. 2) to respond to address resolution requests (such as Address Resolution Protocol, ARP, requests or Neighbor Solicitation messages for IPv6) from external network devices that request an IP identifying an application to be resolved to a MAC address that identifies the desired network function chain. For example, if the operator was configuring a chain for application 33, the operator would know that traffic associated with this application would arrive destined for IP address 135.0.0.33 according to the scheme of FIG. 3 in the case of anycast and ECMP. If the operator desired a network function chain for this application through slots 1 and 2, the operator may configure the switch to respond to an address resolution request for IP address 135.0.0.33 with a MAC address of 52:21:00:00:00:03, which according to the scheme of FIG. 6 identifies both application 33 (i.e., 0x21) and the network function chain through slots 1 and 2. After receiving a response from the switch, the external network device will begin forwarding packets received for IP address 135.0.0.33 to the host device within a frame having the destination MAC address 52:21:00:00:00:03.

It will also be understood that the address resolution functionality may be extended to ranges of addresses. For example, where the same network chain is desired for all applications, the same MAC address can be configured for the IP prefix 135.0.0.32/26 (i.e., all anycast ECMP addresses with a set V bit 335 according to the scheme of FIG. 3). Thus, an ARP request for an address may be answered with a MAC address applying to a range of addresses.

The operator may configure the switch to forward received frames through the network function chain according to configuration information, such as the forwarding rules of FIG. 2. FIG. 7 illustrates exemplary rules 700 for a switch. Generally, each of the rules 700 includes a criteria section 710 for determining whether a rule is applicable and a result section 715 for specifying the action(s) to be taken. It will be understood that such rules may be formed in virtually any manner to convey the information described.

As a first example, a first rule 720 indicates that when the switch receives a frame destined for MAC address 52:21:00:00:00:03 (such as from an outside router or from one of the slots), the switch should modify the frame to instead carry the destination MAC address 52:21:00:00:00:02 (i.e., to unset the bit associated with slot 1 in the bitmap) and then forward the modified frame to slot 1. Thus, the frame is forwarded to the first slot in the network function chain, which has been effectively “marked off” in the packet. In other words, by swapping one address for another, the identification of slot one is removed from the frame.

In the next example, the second rule 730 is applicable when a received frame is destined for MAC address 52:21:00:00:00:02. Such a received frame may be received back from slot 1 after application of the first rule 720 and performance of any processing desired by the network function device in slot 1. In some cases, this second received frame may be the same modified frame that was passed in to slot 1 as a result of applying the first rule 720. In any case, when the second rule is applicable, the switch modifies the destination MAC address to be 52:00:00:00:00:02, thereby switching to the slot addressing scheme of FIG. 6 and removing the bitmap because this step represents the final link in the function chain (i.e., only one bit was set in the bitmap). The switch then forwards the modified frame to slot 2. It will be apparent that further rules may be provided to handle a frame carrying the address 52:00:00:00:00:02 if such a frame is received back from slot 2.

In various embodiments and as shown with respect to rule 730, the last “hop” in a chain is addressed directly to a to a specific slot rather than carrying an empty bitmap. It will be understood that this may be accomplished according to various methods. As shown in the example of FIG. 7, the switch may be programmed with the specific MAC address to insert when clearing the last set bit in the bitmap. Part of this MAC address may be based on the destination IP address. For example, the switch may be configured with an n-bit prefix and may fill the remaining 48-n bits with the tail bits of the IP address. Such a configuration may allow an operator to configure a single chain for a range of IP addresses (e.g. for 135.0.0.32/26) but still address a unique slot for terminating the network function chain.

As described above, various network functions may also be implemented as patches directly to the switch or operating system. For example, the switch may include a load balancer with functionality that may be called directly within the rules. As an example, the third rule 740 applies to the next application (0x22) for frames destined for MAC address 52:22:00:00:00:02. The rule specifies that the MAC address should be changed to 52:00:00:00:00:02 but, instead of specifying a particular port, calls to the load balancing functionality requesting selection between slots 6 and 7. Thus, the operator has configured the second to last bit for application 0x22 to call to switch-integrated functionality and to refer to a different slot (or set thereof) from that used in application 0x21 in rules 720, 730.

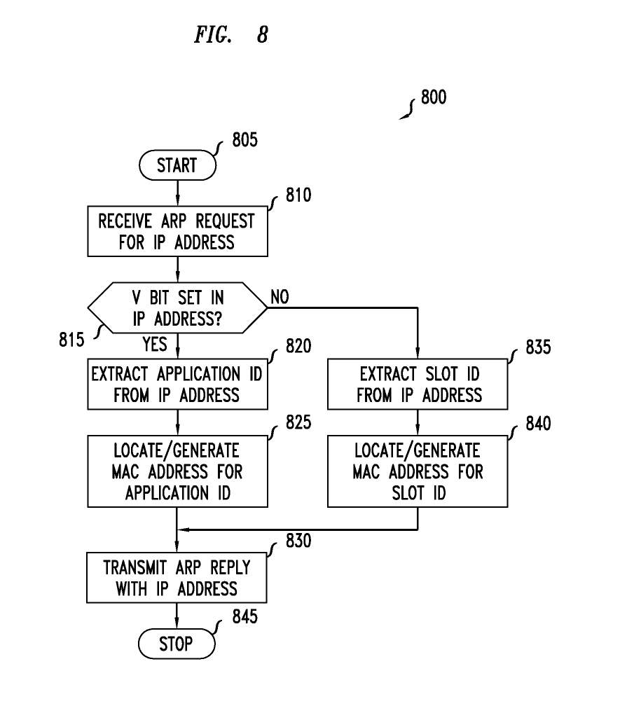

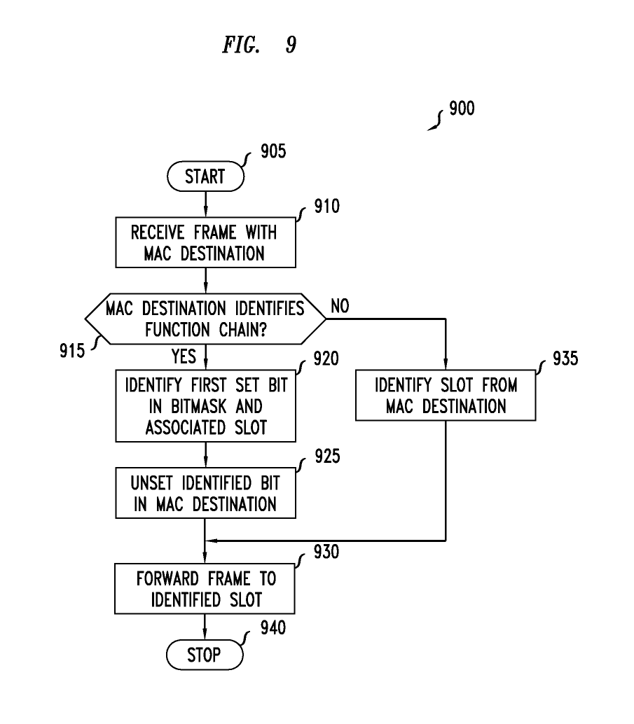

According to the foregoing, the functionality described herein may be implemented in configuration of a switch and its networking logic. However, it will be understood that the various methods described herein may alternatively be implemented procedurally. Exemplary procedures for achieving the functionality described above according to an alternative embodiment are described below with respect to FIGS. 8-9. These figures may also be illustrative of the conceptual operation of the systems described herein and the underlying schemes configured by the operator according to the previously described embodiments.

As noted, a slot may be assigned to any device, whether virtualized or not, within the cloud system. Thus, slots may often correspond to virtualized devices, such as VMs and containers, locally hosted by the host device. Slots may also correspond to other virtualized devices hosted at other host devices or to other physical devices directly. Various techniques may be used to preserve information in the MAC address (e.g. the current bitmap) when the traffic is forwarded to non-local devices. For example, the frame may be encapsulated within another packet or frame to preserve the inner MAC address during routing to the remote device, the information to be preserved may be moved to a field that is preserved on routing, such as the source MAC or source IP address, or each intermediate networking device may be programmed to recognize the MAC address (e.g., by configuring the devices in promiscuous mode).

FIG. 8 illustrates an exemplary method 800 for supporting address resolution. The method may be performed by a host device for responding to an ARP request. The method begins in step 805 and proceeds to step 810 where the host device receives an ARP request for an IP address. The host device then determines which coding scheme is used for the IP address by inspecting the V bit. If the V bit is set, the host device concludes that the IP address identifies an application generally and proceeds to step 820.

In step 820 the host device extracts the application ID from the low order bits of the IP address. The host device then locates or generates a MAC address for the application ID. For example, a MAC address with a function chain may be preconfigured for the application or the host device may generate the MAC from a preconfigured network function chain. The host device then, in step 830, transmits an ARP response with the MAC address to inform the external device how to address future traffic for the IP address. The method then ends in step 845.

If, on the other hand, the host device determines in step 815 that the V bit is not set, indicating that the IP address is directed to a specific slot, the method 800 proceeds to step 835 where the host device extracts the slot identifier from the lowest order bits of the IP address. Then, in step 840, the host device locates or generates a MAC address for addressing the identified slot. The method 800 then proceeds to step 830.

FIG. 9 illustrates an exemplary method 900 for forwarding a received message. The method may be performed by a host device for handling a received frame. The method begins in step 905 and proceeds to step 910 where the host device receives a frame having a MAC address. The frame may be received from an external device or a slot, which may in turn correspond to a locally-hosted virtualized device, a remote virtualized device, or another device within the cloud environment. The host device then determines which coding scheme is used for the MAC address by inspecting the second byte thereof. If the second byte is nonzero, the host address concludes that the MAC address identifies a function chain and proceeds to step 920.

In step 920, the host device identifies the first set bit within the bitmap and notes the corresponding slot. For example, the host device may locate the least significant set bit as the first set bit. Next, in step 925, the switch unsets the identified bit, thereby modifying the MAC address to effectively “cross off” a link in the network function chain. Finally, the host device forwards the frame to the identified slot in step 930 and the method proceeds to end in step 940.

If, on the other hand, the host device determines in step 915 that the second byte of the MAC address is zero, indicating that the MAC address is directed to a specific slot, the method 900 proceeds to step 935 where the host device identifies the slot by reading the value from the lowest four bytes of the MAC address. The method 900 then proceeds to step 930.

According to the foregoing, various embodiments enable the orderly provision and enforcement of network function chains for cloud application traffic in a manner that reduces overhead associated with forwarding traffic between multiple data centers and configuring the varying addresses for the various network functions. Specifically, by providing a special addressing scheme, network functions may be topologically organized and addressable. Further, the addressing scheme may be used to provide stateless tracking of application traffic through the various links of a network function chain. Various additional benefits will be apparent in view of the foregoing.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a host device for directing a message through a network function, the method comprising:
receiving, at the host device, a first received message including a first identification of a first network function;
removing the first identification of the first network function from the first received message to create a first modified message; and
transmitting the first modified message to a first network function device for performance of the first network function with respect to the first modified message.

2. The method of claim 1, wherein the first received message additionally includes a second identification of a second network function, the method further comprising:
receiving, at the host device and based on transmitting the first modified message, a second received message including the second identification of the second network function;
removing the second identification of the second network function from the second received message to create a second modified message; and
transmitting the second modified message to a second network function device for performance of the second network function with respect to the second modified message.

3. The method of claim 1, wherein the first network function device is a virtualized device supported by the host device.

4. The method of claim 1, wherein:
the first received message includes a bitmap including a plurality of bit positions respectively corresponding to a plurality of network functions, and
the first indication of a first network function comprises a bit within the bitmap at a bit position corresponding to the first network function.

5. The method of claim 1, wherein the first identification of the first network function is at least partially represented in a destination address field of the first received message and removing the first identification of the first network function comprises modifying the value of the destination address field.

6. The method of claim 5, wherein the first received message is received from an external router, the method further comprising, before receiving the first received message:
receiving, at the host device from the external router, an address resolution request specifying a first address; and
transmitting, by the host device to the external router, an address resolution response specifying a second address as being associated with the first address, wherein the second address includes the first identification of the first network function.

7. The method of claim 5, wherein the host device supports a plurality of slots via which a plurality of devices are reachable, wherein a first slot of the plurality of slots supports the first network function device, and the step of removing the first identification of the first network function from the first received message to create a first modified message comprises, prior to transmitting the first modified message to the first slot:
setting the destination address field of the first modified message equal to an address of a second slot of the plurality of slots other than the first slot.

8. A host device for directing a message through a network function, the host device comprising:
a network interface;
a memory storing a switch configuration; and
a processor in communication with the network interface and memory, the processor being configured to:
support a plurality of virtualized devices assigned to a respective plurality of slots, and
implement a virtualized switch, wherein the switch is configured to:
receive, via the network interface, a first received message including a first identification of a first slot of the plurality of slots,
remove, based on the switch configuration, the first identification of the first slot from the first received message to create a first modified message, and
transmit the first modified message to a first virtualized device supported by the first slot.

9. The host device of claim 8, wherein the first received message additionally includes a second identification of a second slot of the plurality of slots, the virtualized switch being further configured to:
receive, from the first slot and based on transmitting the first modified message, a second received message including the second identification of the second slot;
remove, based on the switch configuration, the second identification of the second slot from the second received message to create a second modified message; and
transmit the second modified message to a second virtualized device supported by the second slot.

10. The host device of claim 8, wherein:
the first received message includes a bitmap including a plurality of bit positions respectively corresponding to the plurality of slots, and
the first indication of a first slot comprises a bit within the bitmap at a bit position corresponding to the first slot.

11. The host device of claim 8, wherein the first identification of the first slot is at least partially represented in a destination address field of the first received message and, in removing the first identification of the first slot, the virtualized switch is configured to modify the value of the destination address field.

12. The host device of claim 11, wherein the first received message is received from an external router and the switch is further configured to, prior to receiving the first received message:
receive, via the network interface from the external router, an address resolution request specifying a first address; and
transmit, by the host device to the external router and based on the switch configuration, an address resolution response specifying a second address as being associated with the first address, wherein the second address includes the first identification of the first slot.

13. The host device of claim 11, wherein, in removing the first identification of the first slot from the first received message, the virtualized switch is configured to, prior to transmitting the first modified message to the first slot:
setting the destination address field of the first modified message equal to an address of a second slot of the plurality of slots other than the first slot.

14. A non-transitory machine-readable storage medium encoded with instructions for execution by a host device for directing a message through a network function, the non-transitory machine-readable storage medium comprising:
instructions for receiving, at the host device, a first received message including a first identification of a first network function;
instructions for removing the first identification of the first network function from the first received message to create a first modified message; and
instructions for transmitting the first modified message to a first network function device for performance of the first network function with respect to the first modified message.

15. The non-transitory machine-readable storage medium of claim 14, wherein the first received message additionally includes a second identification of a second network function, the non-transitory machine-readable storage medium further comprising:
instructions for receiving, at the host device and based on transmitting the first modified message, a second received message including the second identification of the second network function;
instructions for removing the second identification of the second network function from the second received message to create a second modified message; and
instructions for transmitting the second modified message to a second network function device for performance of the second network function with respect to the second modified message.

16. The non-transitory machine-readable storage medium of claim 14, wherein the first network function device is a virtualized device supported by the host device.

17. The non-transitory machine-readable storage medium of claim 14, wherein:
the first received message includes a bitmap including a plurality of bit positions respectively corresponding to a plurality of network functions, and
the first indication of a first network function comprises a bit within the bitmap at a bit position corresponding to the first network function.

18. The non-transitory machine-readable storage medium of claim 14, wherein the first identification of the first network function is at least partially represented in a destination address field of the first received message and the instructions for removing the first identification of the first network function comprise instructions for modifying the value of the destination address field.

19. The non-transitory machine-readable storage medium of claim 18, wherein the first received message is received from an external router, the non-transitory machine-readable storage medium further comprising, before receiving the first received message:
instructions for receiving, at the host device from the external router, an address resolution request specifying a first address; and
instructions for transmitting, by the host device to the external router, an address resolution response specifying a second address as being associated with the first address, wherein the second address includes the first identification of the first network function.

20. The non-transitory machine-readable storage medium of claim 18, wherein the host device supports a plurality of slots via which a plurality of devices are reachable, wherein a first slot of the plurality of slots supports the first network function device, and the instructions for removing the first identification of the first network function from the first received message to create a first modified message comprise instructions for, prior to transmitting the first modified message to the first slot:
setting the destination address field of the first modified message equal to an address of a second slot of the plurality of slots other than the first slot.
